(19) United States
(12) Patent Application Publication
(10) Pub. No.: US 2014/0244440 A1
(43) Pub. Date: Aug. 28, 2014

(54) METHOD FOR SEARCHING PRODUCTS TO WHICH VISUAL ITEMS ARE APPLIED

(71) Applicants: Jin-San Kim, (US); Joinset Co., Ltd., Ansan-si (KR)

(72) Inventor: Jin-San Kim, Gunpo-si (KR)

(73) Assignees: Joinset Co., Ltd., Ansan-si (KR); Jin-San Kim, Gunpo-si (KR)

(21) Appl. No.: 14/190,300

(22) Filed: Feb. 26, 2014

(30) Foreign Application Priority Data
Feb. 26, 2013 (KR) 10-2013-0020760

(51) Int. Cl. G06Q 30/06

(52) U.S. Cl. CPC G06Q 30/0623; G06Q 30/0643
USPC 705/26.61

(57) ABSTRACT

Disclosed is a method capable of effectively searching products in which a desired design is formed on a desired position. The method includes specifying, by a customer client, a product a customer wants to purchase, specifying a region in which a design is being inserted in the specified product and a design pattern to be inserted, displaying the search target product in which the specified design pattern is inserted on the specified design insertion position in the specified product, transmitting, by the customer client, product information of the specified product and design information including the specified design insertion position and a design pattern to the operation server, and transmitting, by the operation server, the production information and the design information to the data server, and receiving search results based on the product information and the design information to transmit the received information to the customer client.

### REFERENCE TO RELATED APPLICATIONS

This application claims the priority benefit of Korean Patent Application No. 10-2013-0020760 filed on Feb. 26, 2013, the entire contents of which are incorporated herein by reference.

### FIELD OF THE INVENTION

The present invention relates to a product search method, and more particularly, to a product search method in which a product having a desired visual item formed on a desired position may be confirmed with the naked eyes and thus effectively searched.

### BACKGROUND OF THE INVENTION

In order to purchase products, such as clothing, accessories, digital devices or furniture, products having desired designs or functions are investigated through search prior to purchase.

Most shopping mall sites accessible on-line hierarchically classify products according to functions or structures thereof as one of ways allowing customers to easily search desired products.

Nevertheless, since many kinds of products are being released, it is not easy that customers access to desired products. Of course, in the case where a customer searches products having desired functions, the purchase may easily investigate the desired products by using the corresponding function as a search word.

However, in the case of clothing, accessories, digital devices, or furniture in which features which need to be confirmed with naked eyes by customers, for example, colors, shapes, materials or ornaments, and positions associated with designs act as important purchase points, since customers have a great tendency to confirm these products with naked eyes and to purchase desired products, it may be difficult to search clothing or accessories to which such purchase points are reflected, through existing search methods depending on only search words.

For example, when a customer wishes to purchase a round neck short sleeve T-shirt, the customer may access to items of T-shirts through selection in a hierarchical structure or through search by input of a search word and then search short sleeve and round neck T-shirts. However, when the customer wishes to search T-shirts ‘having a check pattern only on a front chest portion’, the customer has to confirm all products investigated through the above search operation one by one.

This is because it is difficult to extract and input a search word in which the feature ‘having a check pattern only on a front chest portion’ is correctly reflected and the search word extracted by the customer may not be stored as a related search word in database provided by a seller.

In conclusion, although the existing search methods are easily accessible to products for purchase, the existing search methods do not disclose a method of efficiently searching products to which specific visual items are applied at specific positions.

### SUMMARY OF THE INVENTION

The present disclosure provides a product search method in which product to specific visual items are applied on specific positions may be efficiently searched while being confirmed with naked eyes.

The above-described object is accomplished by a method of searching products to which visual items are applied, the method being applied to a product purchase system provided with a customer client and an operation server provided with a data server in which product information is stored.

The search method includes selecting, by the customer client, a search target product to convert the selected search target product to a code based on standardization codes provided by the operation server and transmitting the code to the operation server; providing, by the operation sever, a virtual image corresponding to the received code to the customer client; selecting by the customer client a visual item applied to the virtual image and a position into which the visual item is inserted; displaying a virtual image corresponding to a final search target product in which the selected visual item is inserted in the insertion position of the virtual image; converting by the customer client the selected search target product, the selected visual item, and the insertion position to codes, respectively, combining the converted codes to create a final search target product code, and transmitting the created final search target product code to the operation server; and transmitting, by the operation server, the received final search target product code to the data server, receiving search results of the data server and transmitting the received search results to the customer client.

The insertion position may be, among a plurality of regions divided in advance on the virtual image, at least one region selected by the customer client, or a coordinate on the virtual image, which is arbitrarily designated by the customer client.

The visual item may include a design or a partial structure.

The design may have detail information including colors, patterns, materials, and ornaments, and at least one of the detail information may be selected.

### BRIEF DESCRIPTION OF THE DRAWINGS

Exemplary embodiments can be understood in more detail from the following description taken in conjunction with the accompanying drawings, in which:

FIG. 1 is a network diagram for conducting a product search method according to an embodiment of the present invention;

FIG. 2 is a flowchart explaining a product search method according to an embodiment of the present invention; and

FIGS. 3A to 3E show a web browser picture on which a process of conducting a product search method is displayed.

### DETAILED DESCRIPTION OF THE INVENTION

Hereinafter, a method for searching products according to exemplary embodiments of the present invention will be described with reference to accompanying drawings.

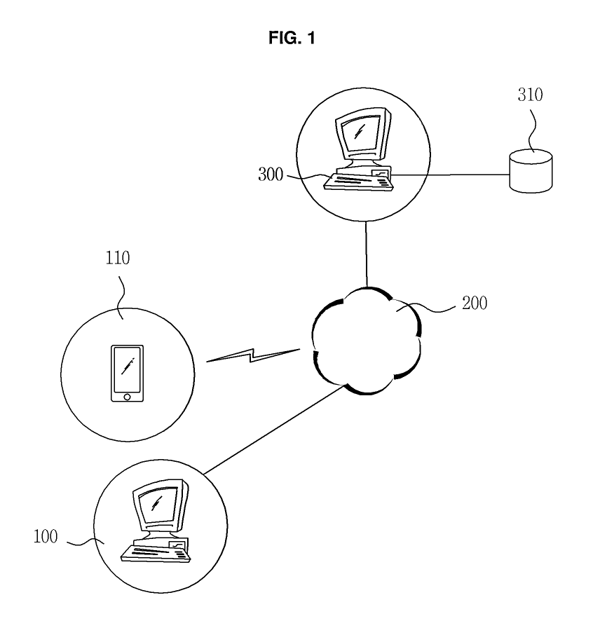

FIG. 1 is a network diagram for conducting a product search method according to an embodiment of the present invention.

In the following description, a computer device, a mobile device, and the like installed on the customer side are referred to as a ‘customer client’, a computer device, a server device, and the like installed on the manufacturer side or the operator side including manufacturers and sellers are referred to as an ‘operation server’, and a communication network connecting the customer client and the operation server is referred to as ‘Internet’.

As might be expected, the customer client and the operation server are all provided with wire and wireless communication functions and displays for displaying information.

Referring to FIG. 1, the customer clients 100 and 110 are accessibly connected to the operation server 300 through the Internet.

The customer clients 100 and 110 select products customers want to search through a screen interface provided by the operation server 300 and then select visual items applied to the selected products and positions in which the visual items are implemented or installed, thus specifying final search target products. Also, the customer clients 100 and 110 create final search target product codes corresponding to the final search target products using standardization codes and provide the created codes to the operation server 300.

By doing so, each of customer clients 100 and 110 handles a load concentrated on the operation server 300 according to code conversion to reduce the load concentrated on the operation server 300.

The operation server 300 has an application related to the method for searching products according to the present invention and provides a screen interface for searching the product to the customer clients 100, 110 in order to carry out the method for searching products in a web browsing environment. Along with this, the operation server 300 provides a virtual image corresponding to the search target products the customer clients 100 and 110 select such that customers may confirm the final search target products to which visual items are applied, with the naked eyes.

The operation server 300 has a data server 310 storing product information therein, and as described above, the product information is basically managed as a standardization code and includes texts, images, and moving pictures.

The product information includes visual items applied to selected positions other than ordinary product information and an virtual image corresponding to each of the products, and is matched to the standardization code provided by the operation server 300 and then stored in the data server 310.

The inputting of product information to the data server 310 may be directly performed by an operator or by a manufacturer, and when the inputting of product information is performed by the manufacturer, the operation server 300 may provide a standardized input screen interface to a manufacturer client and convert the product information to a standardization code to receive the standardization code.

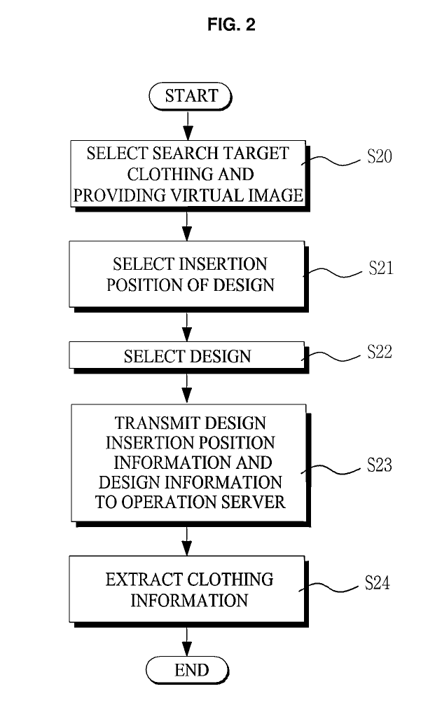

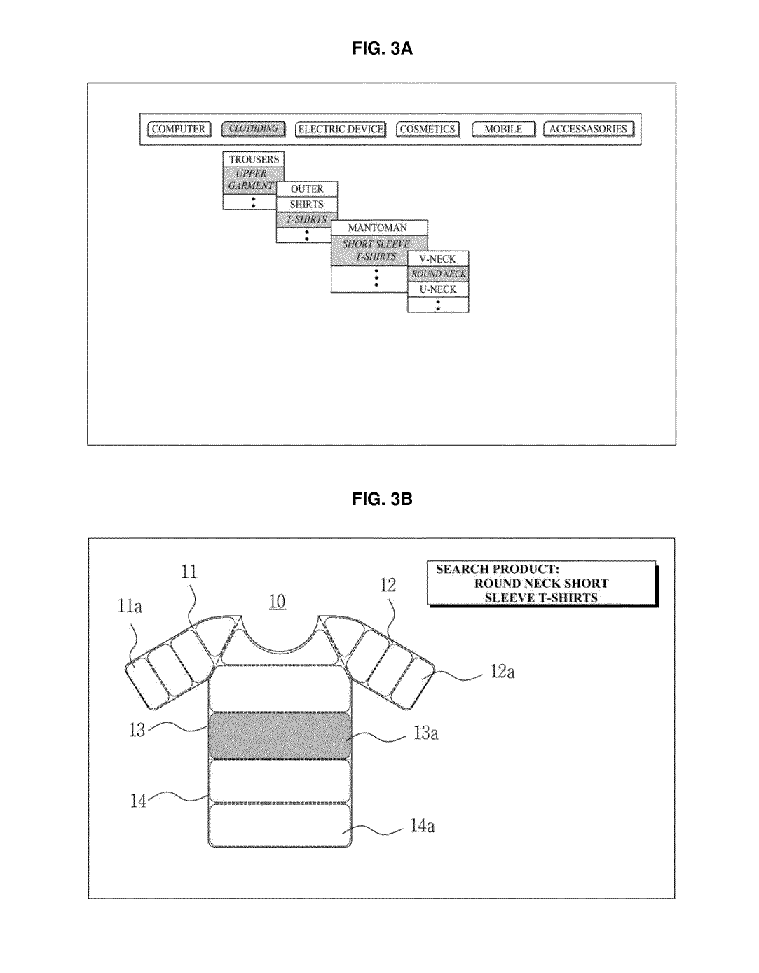

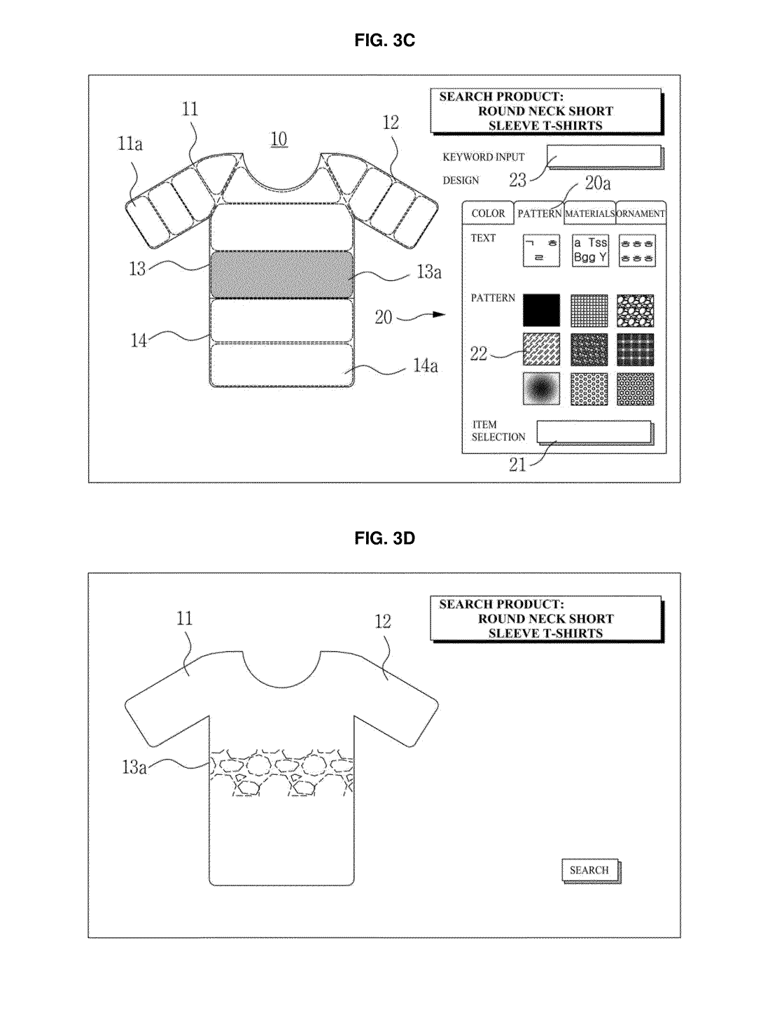

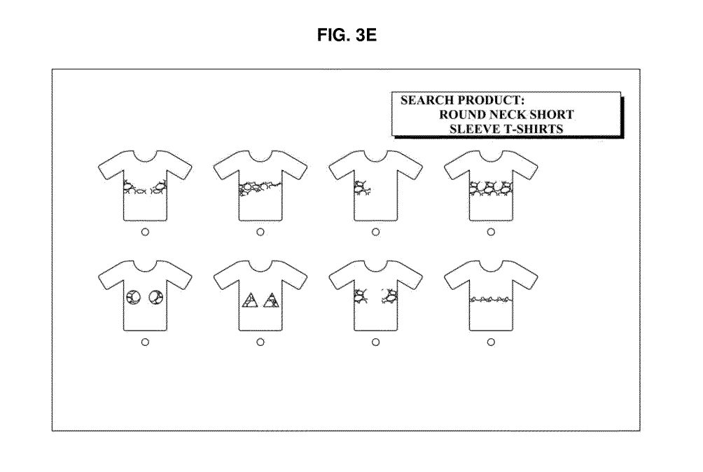

FIG. 2 is a flowchart explaining a product search method according to an embodiment of the present invention, and FIGS. 3A to 3E show a web browser picture on which a process of conducting a product search method is displayed.

The method for searching products according to the present invention includes three processes on the basis of a sequence performed by the customer clients 100 and 110: a first is selecting search target products to receive virtual images corresponding to the search target products; a second is selecting visual items applied to the virtual images and positions implemented or installed thereon; and a third is converting the information selected in the above two processes to be matched with the standardization code provided by the operation server 300.

Hereinafter, for convenience of description, search of clothing in which a visual item, for example, a design is applied on a selected position of clothing in order to purchase the clothing will be exemplarily described, and the present invention is not limited to the method.

Referring to FIG. 2, customer clients 100 and 110 select search target clothing and the operation server 300 provides an virtual image corresponding to the selected clothing (operation S20).

In detail, when the customer clients 100 and 110 operate web browsers and access to the operation server 300 through the Internet 200, the operation server 300 provide a search screen interface on the web browser such that customers may select clothing for search.

For example, in case the customers want to purchase and select round neck and short sleeve T-shirts, two methods may be applied.

First, when the operation server 300 provides a search window to the customer clients 100 and 110, the customer clients 100 and 110 match and convert keywords, such as ‘round neck’, ‘short sleeve’, and T-shirts' inputted by customers to standardization codes provided by the operation server 300 and provide the matched and converted standardization code to the operation server 300. The operation server 300 receives a virtual image corresponding to the received clothing code from the data server 310 and provides the received virtual image to the customer clients 100 and 110.

Also, when the customer selects clothing the customer wants to purchase by using a hierarchical pulldown menu provided by the operation server 300 to the customer clients 100 and 110, the customer clients 100 and 110 match and convert the selected clothing to the standardization code provided by the operation server 300 and provide the matched and converted code to the operation server 300, and the operation server 300 receives the virtual image corresponding to the received clothing code from the data server 310 and provides the received virtual image to the customer clients 100 and 110.

That is, as shown in FIG. 3A, when clothing is selected on menu bars having listed product items, an ‘upper garment’ and ‘trousers’ are displayed as a pulldown, and when the ‘upper garment’ is selected, an ‘outer’, ‘shirts’, and T-shirted’ and the like are displayed as a pulldown, and a ‘round neck’ type may be finally selected by repeating these processes.

As described above, when the clothing the customer wants to purchase is directly inputted by the customer through a search window or selected by using the hierarchical pulldown menu, the customer clients 100 and 110 convert the selected clothing on the basis of the standardization code to a code, for example, H(alf)-TS-R(ound)N(eck) and transmit the code to the operation server 300 while storing the code.

The operation server 300 transmit the received and selected the clothing code to the data server 310, and the data server 310 extracts a corresponding virtual image on the basis of the selected clothing code.

Next, corresponding to the selected search target clothing, a visual item to be implemented or installed on a selected position of the virtual image received from the operation server 300 is selected.

Herein, the visual item may be variously defined according to search target products. For example, the clothing includes a design as the visual item, and the design further includes detail information, such as colors, patterns, materials, or ornaments. Furthermore, an electric apparatus and furniture include a partial structure as a visual item, which may be, for example, a handle, a side speaker, or a corner shape.

In the following description, in order to help understanding, descriptions regarding visual items will be limited only to the design, but the present invention is not limited thereto.

First, an insertion position in which a design is being inserted in a virtual image is selected (operation S21).

In one example, the operation S21 is a process in which the position in which the design is being inserted or implemented in the virtual image provided by the operation server 300 is determined, and may be, for example, performed by using a frame created on the virtual image.

Herein, the frame means a boundary that divides an image into a plurality of regions and includes the respective divided regions therein, and the entire surface including a front surface, a side surface, and a rear surface is divided.

As shown in FIG. 3B, the virtual image of a ‘round neck short sleeve T-shirt’ provided by the operation server 300 may be divided into, for example, four main frames 11, 12, 13, and 14 at a front surface, and each of the four main frames 11, 12, 13, and 14 may be divided into a plurality of sub-frames 11a, 12a, 13a and 14b.

In this embodiment, each of the main frames 11, 12, 13, and 14 is divided to designate a left brachium, a right brachium, an upper body, and a lower body, each of the main frames 11 and 12 is divided into four sub-frames 11a and 12a, and each of the main frames 13 and 14 is divided into three sub-frames 13a and 14b.

It is of course that the divide types and the number of these frames are only exemplified, and other type and the number may be set. Also, while this embodiment shows only the frame formed on the front surface of the upper garment, the rear surface or the side surface may be naturally divided into a frame.

The selection of the main frame or sub-frame may be conducted by using an input device, such as a mouse such that the frame designated by the mouse cursor may be emphasized, for example, displayed in bold, highlighted, or the like, and a plurality of main frames or a plurality of sub-frames belonging to different main frames may be selected at the same time.

Unlike the above example, the insertion position may be specified by using coordinates on the virtual image, not by using a fame unit. In this case, the frame is not needed to be set in advance, and a user may arbitrarily select the insertion position on the virtual image 10.

Herein, as shown in FIG. 3B, it is assumed that the sub frame 13a of the upper body is selected by the customer clients 100 and 110 as the insertion position in which a design is being inserted.

Next, the design inserted into the selected insertion position of the virtual image 10 is selected (operation S22).

Referring to FIG. 3C, the virtual image which the selected insertion position 13a is highlighted is displayed on a screen, and a detail information select window 20 for selecting the design that is being inserted into the insertion position is displayed.

While this embodiment exemplifies colors, patterns, materials, and ornaments as detail information for selecting the design, the present invention is not limited thereto, and for example, logos or trademarks may be further added.

Also, each detail information may be classified into a plurality of information, and for example, the ‘pattern’ may be classified into texts and figures, and the ‘ornament’ may be classified into shapes or materials, such as two dimension/three dimension or metal/nonmetal, or classified into elements, such as pockets/buttons/zippers.

On the selection window 20, taps 20a are allotted per each detail information such that items of the detail information may be easily selected, and an ‘item selection’ window 21 is preferably installed such that when the items listed per detail information are too much, the listed items may be filtered by using the inputted items without identifying the items one by one.

Also, in the case where the design is selected depending on customer's memory, a ‘keyword input’ window 23 is provided such that an item corresponding to the keyword inputted to the window 23 may be linked to the entire details to be displayed on the selection window 20.

While the sequence which items are listed on the tap 20a of detail information is not particularly limited, the sequence may be determined on the basis of an exposure frequency, that is, a frequency selected, or in a way that priorities are given to items to advertisement rates have been paid.

The detail information selected by customers is combined, and is reflected to the insertion position 13a of the virtual image 10 to be displayed one above the other as shown in FIG. 3D.

Herein, as described above, in case a plurality of insertion positions are selected, different designs may be selected on the respective insertion positions.

By way of these processes, since customers may confirm the virtual image in which the selected design is inserted in search target clothing with the naked eye, there is an advantage that the customers may clearly perceive the search target clothing.

When a virtual image in which a selected design, in this example, a pebble pattern is inserted into the insertion position and displayed is specified as final search target clothing, the customer clients 100 and 110 convert and combine the selected search target clothing, the insertion position of the selected design, and the design and transmit the codes to the operation server (operation S23).

As described above, in operation S23, a search target clothing code (H-TS-RN) stored in the customer clients 100 and 110 is extracted, the insertion position of the selected design and the design are converted to code U(nder)C(hest) and code P(ebble), and these codes are combined to create final search target clothing code H-TS-RN-UC-P to transmit the created final search target clothing code to the operation server 300.

The operation server 300 transmits the received final search target clothing code to the data server 310, and the data server 310 extracts pertinent clothing based on the received final search target clothing code to provide the extracted clothing to the operation server 300 (operation S24).

The operation server 300 provides a clothing image received from the data server 310 to the web browsers of the customer clients 100 and 110 for displaying. For example, referring to FIG. 3E, eight round neck short sleeve T-shirts in which a pebble pattern is inserted in various shapes in the insertion position 13a of an upper body of a front surface of T-shirts are searched and displayed.

In other words, all clothing which is round neck short sleeve T-shirts and in which a pebble pattern is formed under a chest is displayed.

As described above, for convenience of customer's selection, a product image is displayed together with text information regarding product description, but a moving picture may be also displayed together.

Thereafter, as well known, the customer may select, among the displayed clothing, a desired clothing to purchase the wanted clothing through a purchase routine.

According to the above-described structure, it is possible to confirm products in which visual items are formed on desired positions with naked eyes and effectively search the products.

The above-disclosed subject matter is to be considered illustrative, and not restrictive, and the appended claims are intended to cover all such modifications, enhancements, and other embodiments, which fall within the true spirit and scope of the present invention. Thus, the scope of the present invention is to be determined by the broadest permissible interpretation of the following claims and their equivalents, and shall not be restricted or limited by the foregoing detailed description.

What is claimed is:

1. A method of searching products to which visual items are applied, the method being applied to a product purchase system provided with a customer client and an operation server provided with a data server in which product information is stored, the method comprising:
selecting, by the customer client, a search target product to convert the selected search target product to a code based on standardization codes provided by the operation server and transmitting the code to the operation server;
providing, by the operation sever, a virtual image corresponding to the received code to the customer client;
when the customer selects a visual item applied to the virtual image and a position into which the visual item is inserted, displaying, by the customer client, a virtual image corresponding to a final search target product in which the selected visual item is inserted in the insertion position of the virtual image;
converting, by the customer client, the selected search target product, the selected visual item, and the insertion position to codes, respectively, combining the converted codes to create a final search target product code, and transmitting the created final search target product code to the operation server; and
transmitting, by the operation server, the received final search target product code to the data server, receiving search results of the data server and transmitting the received search results to the customer client.

2. The method of claim 1, wherein the insertion position is, among a plurality of regions divided in advance on the virtual image, at least one region selected by the customer client, or a coordinate on the virtual image, which is arbitrarily designated by the customer client.

3. The method of claim 1, wherein the visual item comprises a design or a partial structure.

4. The method of claim 3, wherein the design is provide with detail information comprising colors, patterns, materials, and ornaments, and at least one of the detail information is selected.

5. A method of searching products to which visual items are applied, the method being applied to a clothing purchase system provided with a customer client and an operation server provided with a data server in which clothing information is stored, the method comprising:
selecting, by the customer client, a search target product to convert the selected search target clothing to a code based on standardization codes provided by the operation server and transmitting the code to the operation server;
providing, by the operation sever, a virtual image corresponding to the received code to the customer client;
when the customer selects a design applied to the virtual image and a position into which the design is inserted, displaying, by the customer client, a virtual image corresponding to a final search target clothing in which the selected design is inserted in the insertion position of the virtual image;
converting, by the customer client, the selected search target clothing, the selected design, and the insertion position to codes, respectively, combining the converted codes to create a final search target clothing code, and transmitting the created final search target clothing code to the operation server; and
transmitting, by the operation server, the received final search target clothing code to the data server, receiving search results of the data server and transmitting the received search results to the customer client.
